(19) United States
(12) Patent Application Publication
(10) Pub. No.: US 2016/0139806 A1
(43) Pub. Date: May 19, 2016

(54) Independent Ordering Of Independent Transactions

(71) Applicant: Cavium, Inc., San Jose, CA (US)

(72) Inventors: Robert A. Sanzone, Hudson, MA (US); Wilson P. Snyder, II, Holliston, MA (US); Richard E. Kessler, Northborough, MA (US)

(21) Appl. No.: 14/540,656

(22) Filed: Nov. 13, 2014

(51) Int. Cl. G06F 3/06

(52) U.S. Cl. CPC G06F 3/061; G06F 3/0659; G06F 3/0673

(57) ABSTRACT

An input/output bridge controls access to a memory by a number of devices and maintains an order of access requests under virtualization. In particular, the bridge manages and enforces order among multiple independent threads of requests to a memory. The bridge populates a number of ordered lists with received access requests based on a corresponding identifier of each access request. A top list is also maintained, where the top list is populated with access requests and a corresponding translated physical address. The bridge forwards access requests from the top list, maintaining the order of each of the independent threads.

### BACKGROUND

Virtualization facilitates shared memory access among several different devices, whereby a memory interconnect interfaces with the devices using virtual addresses, which are translated to physical addresses of the memory. To enable virtualization, a memory management unit maintains an index of physical and virtual addresses. During a memory access operation, the memory management unit translates a virtual address to a physical address, and returns the physical address in order to access the memory. This translation can occur bi-directionally such that the virtual address is maintained for communications at the device, and the physical address is indicated in operations at the memory.

### SUMMARY

Example embodiments of the present disclosure include a circuit configured to manage and enforce order among multiple independent threads of requests to a memory. The circuit may include a device interface and a memory interface operated by a control circuit. The device interface may operate to receive a plurality of access requests to access a memory from a plurality of devices, and parse each of the access requests to retrieve a respective transaction identifier (TID). The circuit may update a plurality of ordered lists (also referred to as “linked lists”) having entries corresponding to the plurality of access requests, where each of the ordered lists corresponds to a distinct transaction identifier. The circuit may also maintain a top list, which is an ordered list including entries from each of the plurality of ordered lists. The control circuit, via the memory interface, may then forward the access requests to the memory in an order corresponding to the top list. The circuit may forward the access requests of a common TID in the order corresponding to the ordered list, while forwarding access requests having different TIDs independent of order.

In further embodiments, a translation circuit may operate to translate a virtual address component of each of the access requests to a corresponding physical address of the memory. The translated physical address can be updated to a corresponding entry of the top list or an ordered list. The circuit may populate the top list based on an indication of which of the access requests have been updated with a physical address. Alternatively, the top list may be populated independent of this indication, while the access requests are instead forwarded based on this indication. The circuit may populate the top list with entries from each of the ordered lists in a predetermined selection process, such as a round-robin selection. The circuit may further remove an entry from the top list upon forwarding a corresponding access request to the memory.

### BRIEF DESCRIPTION OF THE DRAWINGS

The foregoing will be apparent from the following more particular description of example embodiments of the disclosure, as illustrated in the accompanying drawings in which like reference characters refer to the same parts throughout the different views. The drawings are not necessarily to scale, emphasis instead being placed upon illustrating embodiments of the present disclosure.

FIG. 1 is a block diagram illustrating a data processor in which embodiments of the present disclosure may be implemented.

FIG. 2 is a block diagram illustrating a system implementing the data processor of FIG. 1.

FIG. 3 is a block diagram illustrating an input/output bridge connecting a plurality of devices and a memory in one embodiment.

FIGS. 4A-B illustrate example access request structures.

FIG. 5 illustrates example linked list structures.

FIG. 6 illustrates an example top list structure.

FIG. 7 is a flow chart illustrating a selection of a request in one embodiment.

### DETAILED DESCRIPTION

A description of example embodiments follows.

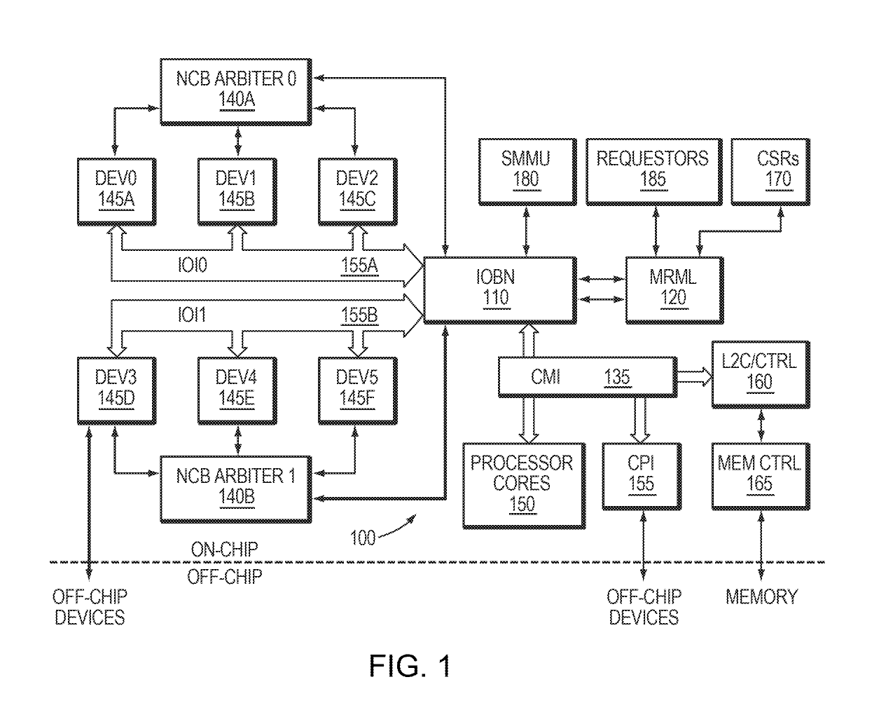

FIG. 1 is a block diagram illustrating a data processor 100 in an example embodiment. The processor 100 may be implemented as a system-on-chip (SOC) and connected to external devices, resources and communications channels via a printed circuit board (PCB). Alternatively, the processor 100 may be implemented among a number of discrete circuit components connected via a PCB, or may comprise a SOC in combination with one or more discrete circuit components.

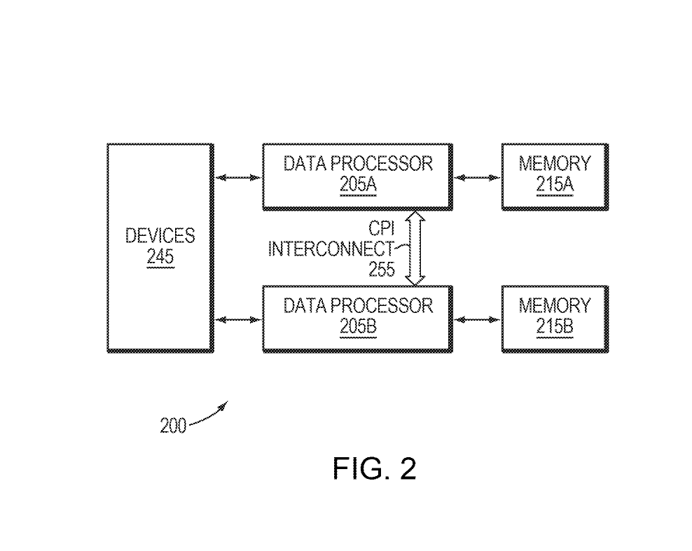

The data processor 100 facilitates operations between a number of devices and resources, and arbitrates access to shared resources among the devices. In particular, the processor cores 150 may include one or more data processor cores. In an example embodiment, the processor cores 150 may include a number (e.g., 48) of ARM® processor cores, such as the ARMv8 processor cores. The processor cores 150 are connected, via a coherent memory interconnect (CMI) 135, to provide shared access to a number of other devices and resources, including the level-2 cache (L2C) and controller 160 (also referred to herein as “L2C”). The L2C further connects to a memory controller 165 for performing memory access operations to an external memory, such as a double data rate synchronous dynamic random-access memory (DDR SDRAM) array. Such a memory (not shown) may alternatively be located on-chip with the data processor 100. The CMI 135 may also connect to a coherent processor interconnect (CPI) 155 for communication with off-chip devices, such as an additional data processor. An example of one such configuration is described below with reference to FIG. 2.

The CMI 135 is further connected to an input/output bridge (IOBN) 110, which provides an interconnect between the processor cores 150, CPI 155 and L2C 160 and additional devices and resources. In particular, devices 145A-F connect to the IOBN 110 via input/output interconnects (IOI), IO10 155A and IOI1 155B, which may be non-coherent buses (NCBs) including passive and/or arbitrated channels. The devices 145A-F may include a number of different on-chip devices, such as co-processors, and may include I/O interfaces (e.g., USB, SATA, PCIe, Ethernet) to connect to a number of external or off-chip devices and interfaces. In order to arbitrate resources at the IOBN 110 to the devices 145A-F, NCB arbiters 140A-B receive requests from the devices 145A-F and selectively grant IOBN resources to the devices 145A-B. Once granted, the devices 145A-B may communicate with the processor cores 150, perform a memory access operation to the L2C 160, or access other components of the data processor 100.

In order to facilitate shared memory access among several different devices (e.g., the processor cores 150 and devices 145A-F), the data processor 100 may employ virtualization, whereby a memory interconnect (e.g., CMI 135 and IOBN 110) interfaces with the devices using virtual addresses, which are translated to a physical address of the memory. To enable virtualization, a System Memory Management Unit (SMMU) 180 maintains an index of physical and virtual addresses. During a memory access operation where a virtual address is provided, the IOBN 110 forwards the virtual address to the SMMU 180, which returns a corresponding physical address for accessing the memory (e.g., the L2C 160 or an external memory via the L2C 160). The IOBN 110 may translate addresses bi-directionally such that the virtual address is maintained at communications at the device, and the physical address is indicated in operations at the memory. The SMMU 180 may be further configured to support multiple tiers of virtual addresses.

Control status registers (CSRs) 170 include registers for maintaining information about the instructions and operations of the data processor 100. The CSRs may maintain, for example, status information regarding a number of devices, as well as information about ongoing operations and instructions between devices and/or resources. Devices such as the processor cores 150 and the devices 145A-B, as well as other requestors 185 and off-chip devices (via the CPI 155), may write to and read from the CSRs 170 using a register master logic (RML). To facilitate the multiple requests from several different devices, a master RML (MRML) 120 operates to arbitrate access to the CSRs 170.

FIG. 2 is a block diagram illustrating a system 200 implementing a plurality of data processors. The system 200 includes data processors 205A-B, each of which may be configured comparably to the data processor 100 described above with reference to FIG. 1. The data processors 205A-B may be linked by a CPI interconnect 255, which may connect to a respective CPI interface (e.g., 155 in FIG. 1) of each data processor 205A-B. The CPI interconnect 255 may provide shared access to the devices and resources across the data processors 201A-B. In further embodiments, additional data processors or other devices may be linked to the data processors 205A-B via the CPI interconnect 255.

The data processors 205A-B may be connected to respective memory arrays (e.g., DDR SDRAM) 215A-B as shown, and/or may be connected to a common memory array. The data processors may be further connected to a number of external devices 245 via a number of devices via respective I/O interfaces (e.g., USB, SATA, PCIe, Ethernet).

Turning back to FIG. 1, in some embodiments, the data processor 100 may employ virtualization, as described above, to facilitate shared memory access among several different devices. Under virtualization a memory interconnect (e.g., CMI 135 and IOBN 110) interfaces with the devices using virtual addresses, and interfaces with a memory (e.g., L2C 160) using corresponding physical address. Each of the devices (e.g., devices 145A-F, processor cores 150) may forward access requests as parts of an independent ordered thread that is specific to the device or another category. The SMMU 180 may operate to translate between virtual and physical addresses. However, the SMMU 180 may return translated address in an order that deviates from the order in which they were received. As a result, pending access requests at the IOBN 110 may be cleared for forwarding in an order that conflicts with the order of a thread.

An IOBN 110, in one embodiment, may be configured to control access to a memory by a number of devices and maintain an order of access requests under virtualization. The IOBN 110 may manage and enforce order among multiple independent threads of requests to a memory. To do so, the IOBN 110 may populate a number of ordered lists with received access requests based on a corresponding identifier of each access request. The IOBN 110 may also maintain a top list, which is populated with access requests and a corresponding translated physical address. The IOBN 110 may then selectively forward access requests from the top list, maintaining the order of each of the independent threads.

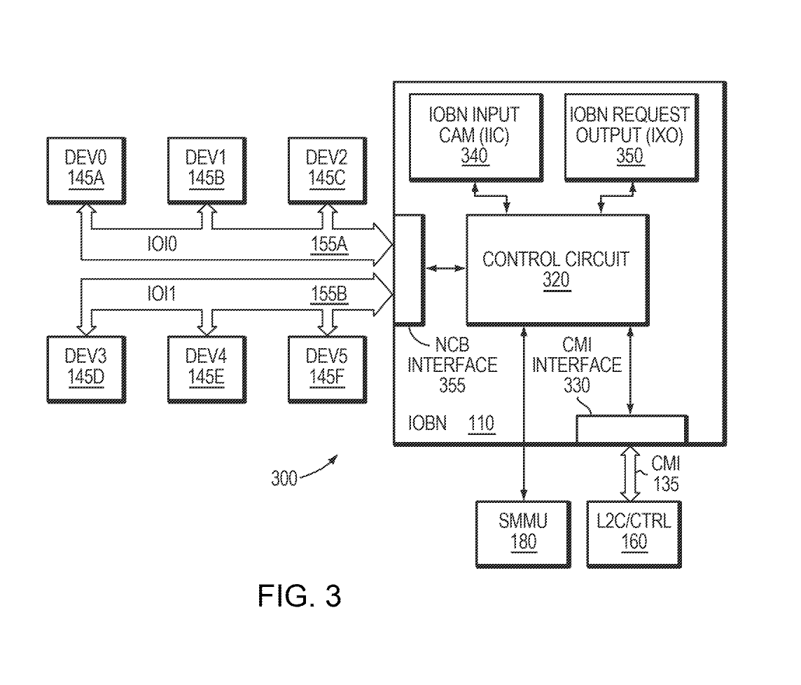

An example IOBN 110 configured to provide the aforementioned functions is described below with reference to FIG. 3.

FIG. 3 is a block diagram illustrating a processing subsystem 300 including an IOBN 110 connecting a plurality of devices 145A-F and a memory (L2C 160) in one embodiment. The subsystem 300 may include one or more components of the data processor 100 described above with reference to FIG. 1, or may be incorporated into the data processor. For example, the subsystem 300 may also include processor cores 150 and process access requests from the processor cores 150 as well as from the devices 145A-F.

The IOBN 110 includes a non-coherent bus (NCB) interface 355 for communicating with the devices 145A-F via intermediary NCBs, IO10 155A and IO11 155B. The IOBN 110 also includes a CMI interface 330 for communicating with the L2C 160 via the CMI 135. The IOBN 110 further includes a control circuit 320 and content addressable memory (CAM), including an IOBN input CAM (IIC) 340, and an IOBN request output (IXO) 350. Alternatively, the IIC 340 and IXO 350 may be located separately from the IOBN 110.

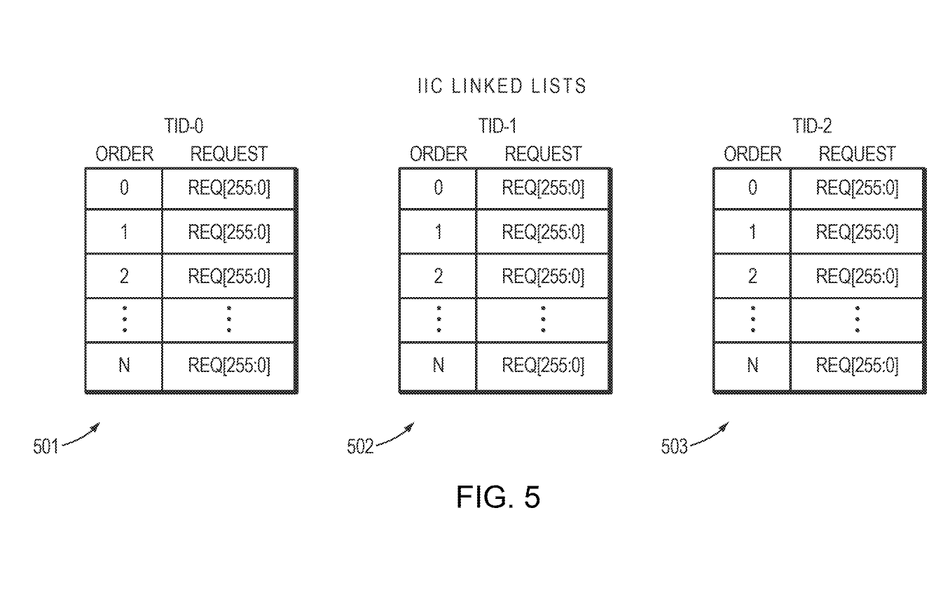

The devices 145A-F may forward memory access requests to the L2C 160 via the IOBN 110, for example to read or write to the L2C 160. The IIC 340 stores a plurality of ordered lists (also referred to as “linked lists”) that maintains access requests of a common type in a specified order, such as in the order in which the access requests were sent from a device. In one example, each device 145A-F may be assigned a set of one or more unique transactions IDs (TIDs). The IIC 340 maintains a separate, ordered list for each TID, and adds each received access request to the respective list based on its TID. Thus, each device 145A-C can maintain order among a particular thread of access requests by assigning those requests a common TID. Conversely, unrelated access requests that do not require a specific order (i.e., can be completed in any order) can be assigned different TIDs, enabling the requests to be sent independently of one another. Alternatively, if requests among two or more of the devices 145A-F must be sent to the L2C 160 in a given order, then the two or more devices 145A-F may be assigned one or more common TIDs. Example structures of ordered lists at the IIC are described below with reference to FIG. 5.

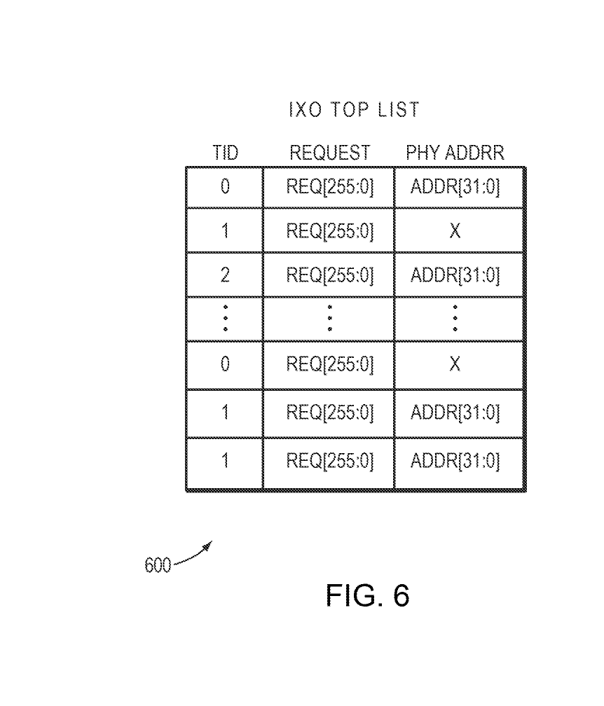

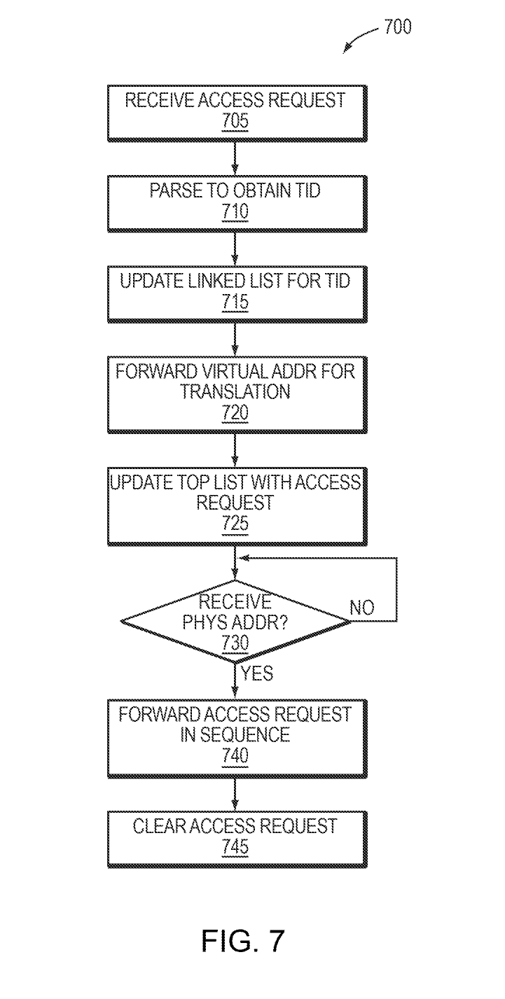

The control circuit 320 may operate to populate the IIC 340 with received access requests based on their respective transaction ID as described above. Further, the control circuit 350 may forward the access requests to the SMMU 180 for virtual-to-physical address translation, and may selectively populate the IXO 350. The IXO 350 may maintain a single “top” list of access requests for forwarding to the L2C 160. An example structure of a top list maintained by the IXO 350 is described below with reference to FIG. 6. When the IXO 350 is populated with a number of access requests from different lists of the IIC 340, the control circuit 320 may select a next request to forward to the L2C 160 based on 1) a selection routine, such as a round-robin selection, and 2) which of the access requests have received a translated physical address from the SMMU 180. As a result, the IOBN 110 can forward translated access requests to the L2C in an order that is preserved for requests having common TIDs, and access request having different TIDs are permitted to pass one another. An example process for processing and selecting access requests are described in further detail below with reference to FIG. 7.

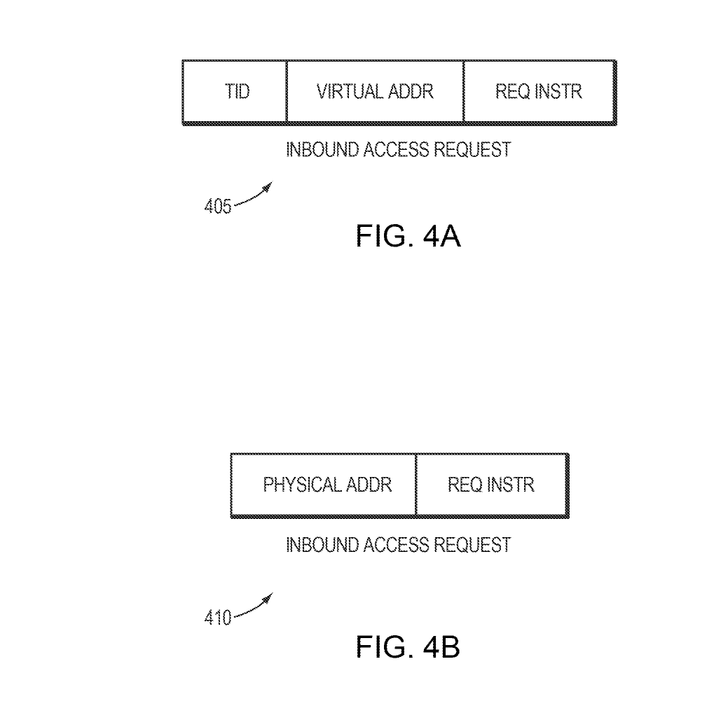

FIGS. 4A-B illustrate example access requests. As shown in FIG. 4A, an inbound access request 405, as provided by a device (e.g., devices 145A-F) to a bridge (e.g., IOBN 110), includes a TID, a virtual address, and request instructions (e.g., commands and data making up the body of the access request). In contrast, as shown in FIG. 4B, an outbound access request 410, as processed by the IOBN 110 and forwarded to a memory (e.g., L2C 160), includes the translated physical address and the request instructions. In some embodiments, the TID may be excluded from the outbound access request 410. Alternatively, if the L2C 160 is configured to utilize the TID, the outbound access request 410 may include the TID.

FIG. 5 illustrates a number of example ordered, linked-list structures 501-503 that may be maintained by the IOBN 110 at the IIC 340. Each list 501-503 is associated with a particular TID (e.g., TID-0, TID-1, TID-2), and maintains each request in an order in which it was received from a device. Access requests may be added to a corresponding list 501-503 upon receipt from a device, and may be cleared from a list 501-503 upon an indication that the request has been added to the top list or has been forwarded to the L2C 160.

FIG. 6 illustrates an example top list structure 600 that may be maintained by the IOBN 110 at the IXO 350. The top list 600 maintains a list of all access requests from each of the linked lists at the IIC 340, and includes an entry for the corresponding physical address when received by the SMMU 180. Access requests may be held in the top list 600 until the corresponding physical address is received. For the next request to send to the L2C 160, the IOBN 110 may select (e.g., in a round-robin fashion) from among the entries in the top list 600 that have physical addresses, and may clear entries from the top list 600 upon sending them to the L2C 160. Alternatively, the IOBN 110 may add access requests to the top list 600 only upon receiving a corresponding physical address.

FIG. 7 is a flow chart illustrating a process 700 of processing and selecting a request in one embodiment. With reference to FIG. 3, the IOBN 110 receives an access request from one of the devices 145A-F (705), parses the request to obtain a TID (710), and adds the request to a linked list (at the IIC 340) corresponding to the TID (715). The IOBN also parses a virtual address portion of the access request and forwards the virtual address to the SMMU 180 for translation (720). While awaiting a returned physical address from the SMMU 180, the IOBN 110 may update a top list at the IXO 350 with the access request (725).

To select a next access request to forward to the L2C 160, the IOBN may select from among the entries in the IXO 350 (e.g., in a round-robin fashion) that have a corresponding physical address. Thus, when the given access request is considered, if the IOBN 110 has received its corresponding physical address from the SMMU 180 (730), then the IOBN 110 forwards the access request 740 to the L2C 160 (740) and clear the request from the top list at the IXO 350 (745). If the access request does not yet have a physical address when considered, the IOBN 110 may skip the request and reconsider the request in a subsequent selection round. Alternatively, the operations of updating the top list (725) and checking a physical address (730) may be reversed, such that the access request is added to the top list only upon receiving a physical address.

While this invention has been particularly shown and described with references to example embodiments thereof, it will be understood by those skilled in the art that various changes in form and details may be made therein without departing from the scope of the invention encompassed by the appended claims.

What is claimed is:

1. A memory control circuit comprising:
a device interface configured to:
receive a plurality of access requests to access a memory from a plurality of devices;
parse each of the plurality of access requests to retrieve a respective transaction identifier; and
update a plurality of ordered lists having entries corresponding to the plurality of access requests, each of the plurality of ordered lists corresponding to a distinct transaction identifier; and
a memory interface configured to:
update a top list, the top list being an ordered list including entries from each of the plurality of ordered lists; and
forward the plurality of access requests to the memory in an order corresponding to the top list.

2. The memory control circuit of claim 1, further comprising a translation circuit configured to translate a virtual address component of each of the plurality of access requests to a corresponding physical address of the memory.

3. The memory control circuit of claim 2, wherein the translation circuit updates the plurality of access requests to include the corresponding physical address of the memory.

4. The memory control circuit of claim 3, wherein the memory interface is further configured to populate the top list based on an indication of which of the plurality of access requests have been updated with the corresponding physical address of the memory.

5. The memory control circuit of claim 1, wherein the memory interface is further configured to populate the top list with the entries from each of the plurality of ordered lists using a round-robin selection.

6. The memory control circuit of claim 1, wherein the memory interface is further configured to remove an entry from the top list upon forwarding a corresponding one of the plurality of access requests to the memory.

7. A method of controlling access to a memory, comprising:
receiving a plurality of access requests to access a memory from a plurality of devices;
parsing each of the plurality of access requests to retrieve a respective transaction identifier;
updating a plurality of ordered lists having entries corresponding to the plurality of access requests, each of the plurality of ordered lists corresponding to a distinct transaction identifier;
updating a top list, the top list being an ordered list including entries from each of the plurality of ordered lists; and
forwarding the plurality of access requests to the memory in an order corresponding to the top list.

8. The method of claim 1, further comprising translating a virtual address component of each of the plurality of access requests to a corresponding physical address of the memory.

9. The method of claim 2, further comprising updating the plurality of access requests to include the corresponding physical address of the memory.

10. The method of claim 3, further comprising populating the top list based on an indication of which of the plurality of access requests have been updated with the corresponding physical address of the memory.

11. The method of claim 1, further comprising populating the top list with the entries from each of the plurality of ordered lists using a round-robin selection.

12. The method of claim 1, further comprising removing an entry from the top list upon forwarding a corresponding one of the plurality of access requests to the memory.
